(19) United States
(12) Patent Application Publication
(10) Pub. No.: US 2026/0029524 A1
(43) Pub. Date: Jan. 29, 2026

(54) HYBRID FIRA DL-TDOA AND UWB RADAR MODE

(71) Applicant: Cisco Technology, Inc., San Jose, CA (US)

(72) Inventors: Ardalan Alizadeh, Milpitas, CA (US); Peiman Amini, Fremont, CA (US); Jerome Henry, Pittsboro, NC (US); Navid Reyhanian, Santa Clara, CA (US); Rabe Arshad, Milpitas, CA (US)

(21) Appl. No.: 19/203,583

(22) Filed: May 9, 2025

Related U.S. Application Data
(60) Provisional application No. 63/676,699, filed on Jul. 29, 2024.

(51) Int. Cl. G01S 13/75; G01S 7/00; G01S 7/40; G01S 13/87

(52) U.S. Cl. CPC G01S 13/758; G01S 7/006; G01S 7/40; G01S 13/876

(57) ABSTRACT

In one aspect, a method is disclosed. The method includes transmitting, from a first anchor in an Ultra-Wide Band (UWB) network, a poll message to a second anchor associated with the UWB network, wherein the poll message includes a first indication of radar usage by the first anchor. The method includes receiving, from the second anchor at the first anchor, a response message in response to the poll message. The response message includes a second indication of radar usage by the second anchor. The method includes determining, by the first anchor, a format of at least one ranging frame to enable dual radar and downlink time difference of arrival (DL-TDoA) ranging by one or more of the first anchor and the second anchor based on the poll message and the response message.

### CROSS-REFERENCE TO RELATED APPLICATION

This application claims the benefit of U.S. Provisional Patent Application No. 63/676,699 filed Jul. 29, 2024, which is incorporated by reference herein in its entirety.

### TECHNICAL FIELD

The present disclosure relates to wireless communication, and in particular to enabling ultra-wide band (UWB) radar detection on Fine Ranging (FiRa) enabled systems using downlink time difference of arrival (DL-TDoA).

### BACKGROUND

Ultra-Wide Band (UWB) is a wireless technology that enables accurate indoor positioning and location-based services, up to 10 cm precise, even in challenging indoor environments which makes it ideally suited to enable real-time measurement of location, distance, and direction, while also supporting two-way communication.

IEEE 802.15.4 standard for wireless communication defines the operations of UWB. One of the widely adopted UWB-based standards is provided by Fine Ranging (FiRa) Consortium. FiRa Consortium is an industry alliance focused on promoting the adoption and interoperability of Ultra-Wideband (UWB) technology for secure, high-precision location-based services. FiRa's primary goal is to ensure seamless UWB integration across various consumer and enterprise applications. FiRa Consortium is consumer-driven, focusing on secure, short-range communication for devices like smartphones, smart access, and IoT applications. FiRa Consortium's signaling procedures are more opportunistic in nature and hence more secure.

While FiRa consortium allows two-way ranging (TWR) and DL-TDoA methods, there is no structure defined in FiRa Consortium's standards for the radar usage of UWB systems.

### BRIEF DESCRIPTION OF THE DRAWINGS

To easily identify the discussion of any particular element or act, the most significant digit or digits in a reference number refer to the figure number in which that element is first introduced.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example environment operating based on FiRa (UWB) standard, according to some aspects of the present disclosure.

FIG. 2A illustrates an example default FiRa DL-TDoA standard structure according to some aspects of the present disclosure.

FIG. 2B illustrates an example FiRa structure that enables radar detection according to some aspects of the present disclosure.

FIG. 3A and FIG. 3B each illustrates a flow-chart of an example method that enables dual radar detection and FiRa DL-TDoA operations, according to some aspects of the present disclosure.

FIG. 4 shows an example of a system for implementing certain aspects of the present technology according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to a person of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

Aspects of the present disclosure are directed to defining new roles for anchors in a FiRa-enabled environment and signaling procedures and methods that enable UWB radar detection on FiRa-enabled systems.

In one aspect, a method includes transmitting, from a first anchor in an Ultra-Wide Band (UWB) network, a poll message to a second anchor associated with the UWB network, wherein the poll message includes a first indication of radar usage by the first anchor; in response to the poll message, receiving, from the second anchor at the first anchor, a response message including a second indication of radar usage by the second anchor; and determining, by the first anchor, a format of at least one ranging frame to enable dual radar and downlink time difference of arrival (DL-TDoA) ranging by one or more of the first anchor and the second anchor based on the poll message and the response message.

In another aspect, the first indication and the second indication identify a mode of radar for the radar usage by the corresponding first anchor and the corresponding second anchor.

In another aspect, the mode of radar includes one of a mono-static radar, a bistatic radar, or a multi-static radar.

In another aspect, the poll message further includes a buffer status request parameter, and the response message further includes a buffer status report parameter, and airtime usage for radar by the second anchor is prohibited based on information included in the buffer status report parameter.

In another aspect, the method further includes upon receiving the response message from the second anchor, determining, by the first anchor, whether performance of the DL-TDoA has degraded relative to a threshold, and transmitting, by the first anchor to the second anchor, a final message including a third indication of radar usage parameter to prohibit the second anchor from using radar if the performance of the DL-TDoA has degraded relative to the threshold.

In another aspect, the performance of the DL-TDoA is determined based upon one or more of Received Signal Strength Indicator (RSSI) and range standard deviation.

In another aspect, at least one of the first anchor and the second anchor operates in a mono-static radar mode.

In another aspect, determining the format of the at least one ranging frame includes adding a ranging round to the at least one ranging frame, assigning a first length to a first set of ranging rounds to be assigned for radar ranging, and assigning a second length to a second set of ranging rounds to be assigned for DL-TDoA ranging.

In another aspect, the second length is different from the first length or same as the first length.

In another aspect, the second set of ranging rounds is before the first set of ranging rounds in the ranging frame.

In another aspect, the first length is different than the second length.

In another aspect, the first length corresponding to a length of each slot in the first set of ranging rounds is shorter than the second length corresponding to a length of each slot in the second set of ranging rounds.

In another aspect, at least one of the first anchor and the second anchor is configured to operate as a transmitting and receiving radar anchor.

In another aspect, determining the format of the at least one ranging frame further includes a static slot assignment or a dynamic slot assignment.

In another aspect, the static slot assignment utilizes a number and an order for the first set of ranging rounds that are provided by a central configuration server.

In another aspect, the first anchor provides a number of slots in the first set of ranging rounds based on a radar priority number of the second anchor in a cluster of anchors.

In another aspect, the number of slots is provided in a reply message by the second anchor to the first anchor.

In another aspect, a duration of each radar ranging round in the at least one ranging frame is equal to a duration of each DL-TDoA ranging round in the at least one ranging frame.

In another aspect, the method further includes determining a number of slots and a corresponding duration for each of the slots in each radar ranging round subject to the duration of each radar ranging round being equal to the duration of each DL-TDoA ranging round.

In another aspect, at least one of the first anchor and the second anchor operates in a multi-static radar mode or a bistatic radar mode with directional antennas.

In another aspect, at least one of the first anchor and the second anchor has a directional antenna.

In another aspect, the method further includes compensating for Carrier Frequency Offset in each radar ranging round.

In another aspect, at least one of the first anchor and the second anchor is associated with a radar group including a plurality of radar-enabled anchors.

In another aspect, a round index for radar ranging is one plus a maximum round index for DL-TDoA ranging in the radar group.

In another aspect, the first anchor or the second anchor has a mode of radar for the radar usage as a multi-static radar or a bistatic radar.

In another aspect, the first anchor or the second anchor does not have directional antennas with directional antenna capabilities.

In another aspect, the second anchor performs successive interference cancellation by regenerating radar frames included in a signal received from the first anchor based on frames detected during a radar ranging round or based on channel information extracted from a previous DL-TDoA ranging round and removing the radar frames from the signal.

In another aspect, the channel information is applied to a baseband preamble in the radar frames to determine a radar channel impulse response.

In one aspect, an apparatus in an Ultra-Wide Band (UWB) network is disclosed. The apparatus includes at least one memory configured to store computer-readable instructions; and at least one processor communicatively coupled with the at least one memory, and configured to execute the computer-readable instructions to perform operations including transmitting, to an anchor associated with the UWB network, a poll message including a first indication of radar usage by the apparatus; in response to the poll message, receiving, from the anchor, a response message including a second indication of radar usage by the anchor; and determining a format of at least one ranging frame to enable dual radar and downlink time difference of arrival (DL-TDoA) ranging by one or more of the apparatus and the anchor based on the poll message and the response message.

In one aspect, a non-transitory computer-readable medium includes computer-readable instructions, which, when executed by at least one processor of an apparatus in an Ultra-Wide Band (UWB) network, cause the apparatus to perform operations including transmitting, to an anchor associated with the UWB network, a poll message including a first indication of radar usage by the apparatus; in response to the poll message, receiving, from the anchor, a response message including a second indication of radar usage by the anchor; and determining a format of at least one ranging frame to enable dual radar and downlink time difference of arrival (DL-TDoA) ranging by one or more of the apparatus and the anchor based on the poll message and the response message.

### Example Embodiments

FiRa TWR and DL-TDoA are being enabled in WiFi-7 APs. However, there is no specific structure defined in FiRa for the radar usage of UWB systems. Currently, each provider/vendor in the industry has developed its own way of using CIR-based radar techniques for specific use-cases, and there is no standard method for such usages that can coexist with other UWB modes of operation.

The present disclosure is directed to integration of FiRa standards with DL-TDoA and UWB radar technology that can provide a robust, secure, and efficient solution for real-time locating systems, driving forward the capabilities of modern tracking and navigation applications. Further, as described herein, usage of collaborative mono-static or multi-static radar in enterprise environments leveraging ceiling-mounted APs equipped with UWB introduces many different opportunities that provide features such as presence detection, employee counting, and even more precise positioning, such as desk-level occupancy detection and tracking. Many of the features defined in FiRa, such as emergency alerting for hazardous zones, etc., are based on, or employ, radar features.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

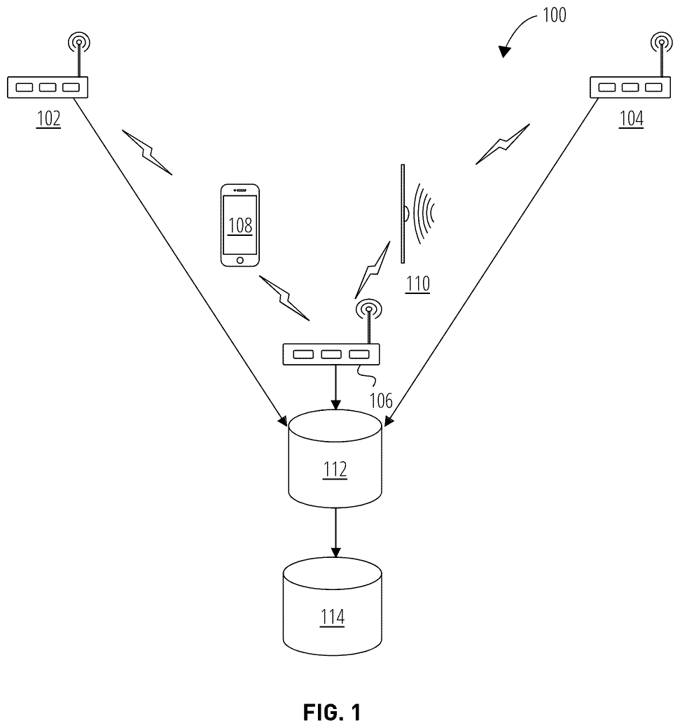

FIG. 1 illustrates an example environment operating based on FiRa (UW B) standard, according to some aspects of the present disclosure.

In one example, environment 100 (which may also be referred to as an ecosystem or architecture) includes a plurality of UWB anchors such as anchor 102, anchor 104, and anchor 106, a plurality of tags such as tag 108 and tag 110, a positioning server such as server 112, and an application layer server such as application layer server 114. It should be noted that environment 100 may include any other known or to be developed component such as additional servers, communication components, etc. Furthermore, the number of various components such as anchors and tags are not limited to those shown in FIG. 1 and may be more or less.

Each one of anchor 102, anchor 104, and anchor 106 may be a fixed device capable of emitting and receiving (transmitting and receiving) UWB signals. In one example, such UWB signals may be utilized to determine a distance between a given anchor and a given tag as will be described in more detail below. Each of anchor 102, anchor 104, and anchor 106 may be an access point (AP), a UWB base station, and/or any other device capable of transmitting and receiving UWB signals and communicating with co-located and/or cloud-based servers such as server 112 and application layer server 114.

A tag may be any device that includes a UWB transceiver capable of communicating with an anchor. In non-limiting example of FIG. 1, tag 108 is a mobile device and tag 110 may be any known or to be developed UWB tag that may be wearable and capable of tracking assets, people, vehicles and equipment in various industrial and retail settings, etc.

Server 112 can be referred to as a positioning server. Server 112 can be any on-premise and/or cloud-based server that is capable of communicating with anchor 102, anchor 104, and/or anchor 106. For example, server 112 can receive raw data from anchor 102, anchor 104, and/or anchor 106 and process the data to determine location of tag 108 and/or tag 110. As described below, server 112 may also function as a central synchronizer, a central orchestrator, or a central reference generator to coordinate ranging blocks for FiRa and Omlox systems.

Server 112 may be implemented using any known or to be developed Real-Time Location Service (RTLS) server, a UWB server, any known or to be developed public, provider, or hybrid cloud server, etc.

Application layer server 114 may be a server executing software application to provide real-time location data to end users and applications. Such software application may be any known or to be developed application including, but not limited to, commercially available asset tracking systems, indoor navigation applications, etc.

In order to determine a location of a tag, each anchor (e.g., anchor 102) may receive a signal transmission (e.g., a beacon or a pulse) from a tag such as tag 108. Using Time Difference of Arrival (TDoA) or Two-Way Ranging (TWR), an anchor can determine a distance between that anchor and any tag with which the anchor communicates. The TDoA can be an Up Link TDoA (UL-TDoA) or a Down Link TDoA (DL-TDoA).

Determining a distance between an anchor and a tag is made possible using a ranging block. Each anchor (e.g., anchor 102, anchor 104, and anchor 106) and each tag (e.g., tag 108 and tag 110) has a ranging block. A ranging block can handle Time of Flight (ToF) or TDoA calculations for localization and ultimately location determination.

For example, using a ranging block, an anchor or a tag can send and receive UW B pulses and record timestamps associated with each. By measuring time delay between transmitted and received signals using techniques such as TWR, UL-TDoA, and/or DL-TDoA, a distance between the anchor and the tag can be determined. TWR is a technique whereby round-trip time between a tag and an anchor is measured using transmitted and received pulses. UL-TDoA and DL-TDoA are techniques whereby a difference in arrival time at multiple anchors is used to measure a distance between each anchor and a tag.

In order to accurately determine distances between anchors and tags, ranging blocks of anchors and/or tags are synchronized. This synchronization can be achieved via various techniques including, but not limited to, a shared clock signal by anchors, periodic UWB broadcast messages (can be broadcasted by server 112 or a designated master anchor (e.g., one of anchor 102, anchor 104, and anchor 106), etc.

A ranging block may include several physical components including, but not limited to, a UWB transceiver, timing and clock synchronization unit, a signal processing unit, a data interface module, and a power management component. Specifications of a ranging block are defined by IEEE 802.15.4z specifications.

A ranging block may have a duration that refers to a time taken to complete a full ranging transaction between an anchor and a tag. The duration may be set according to the underlying ranging method used (e.g., TWR v. TDoA) and/or the required accuracy of location determination of assets (e.g., in a hospital v. a warehouse). For example, a duration of a ranging block may be set to 1 second. Each ranging block may include a plurality of ranging rounds. For instance, a ranging block can include 8 ranging rounds (4 active and 4 passive rounds), as will be further described below.

A ranging round is a complete cycle of message exchanges between a UW B tag and one or more UWB anchors to determine the distance (range) therebetween. Each ranging round consists of transmitting and receiving UWB pulses, recording timestamps, and performing distance calculations based on ToF and TDoA measurements.

Using distances determined by anchors and angle data from the anchors, server 112 can accurately determine a position of a given tag, which can be forwarded to application layer server 114 to be displayed in real-time on a terminal for asset tracking, navigation, and/or any other relevant application.

This network can support applications such as real-time location services, asset tracking, and environmental monitoring.

Aspects of the present disclosure are directed to defining new roles for anchors in a FiRa-enabled environment and signaling procedures and methods that enable UWB radar detection on FiRa-enabled systems.

In a FiRa-enabled system, an anchor typically operates as an Initiator DT-Anchor and Responder DT-Anchor. According to aspects of the present disclosure, an anchor is given a number of additional roles per ranging round (RR) including a transmitting (TX) Radar-Anchor role, a Receiving (RX) Radar-Anchor role, and a derived Transmission/Reception (TRX) Radar-Anchor roles with a high radio frequency (RF) isolation between RX and TX for a mono-static radar.

The TX radar-anchor can generally have three different antenna modes including omni, directional, and sweeping modes. The omni antenna mode is used for inter-anchor communications in DL-TDoA and when the radar does not have a dedicated directional antenna. The directional antenna mode has low antenna gain in the horizontal angle which makes the TX frames not being heard by the surrounding anchors while the maximum gain angle is in the front and facing ground. For the omni and directional antenna modes, the RX Radar-Anchor has an array of antenna at the receiver side to identify the Angle of Arrival (AoA) of the reflected signals. In the sweeping antenna mode, in TX Radar-Anchors, the transmitter sweeps the spaces to generate a two-dimensional (2D) map or a three-dimensional (3D) map of the environment in which the FiRa-enabled anchors and tags are deployed (e.g., environment 100 of FIG. 1).

An anchor may determine, or may be provided information, on the anchor's own role in a certain round index associated with a RR. Accordingly, the initiator DT-anchor with RR index 0 sends poll messages and all other anchors in the entire network, or a cluster set, only listen. The first poll message causes the responder anchors of the cluster 0 to reply back with DL-TDoA messages (DTMs). The DTMs include the initiator anchors of the other clusters. Then the responder anchors of the next cluster reply back to the initiator anchors in the corresponding RR.

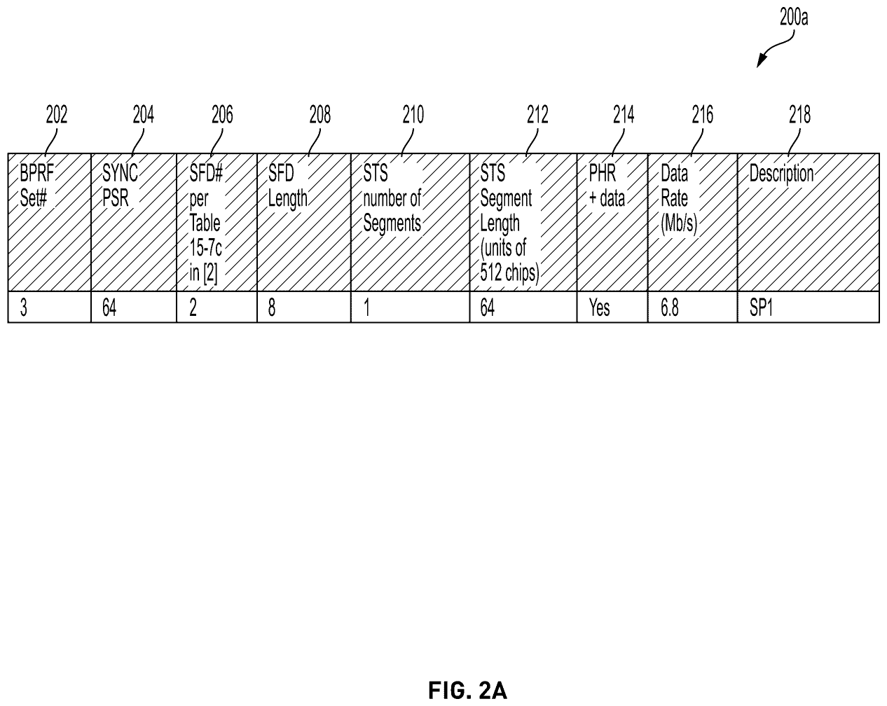

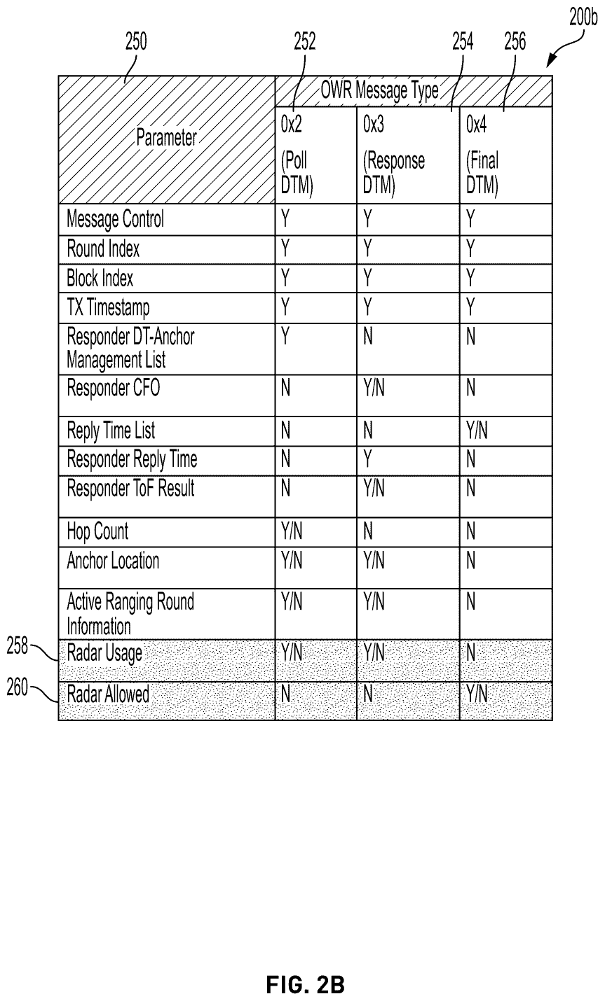

FIG. 2A illustrates an example structure of a Device Test Mode frame, according to some aspects of the present disclosure. Example structure 200a may include 9 exemplary fields. Field 202 may be referred to as Base Pulse Repetition Frequency (BPRF) mode #3 as defined in the standards. Field 204 indicates synchronization (SY NC) Preamble Synchronization Repetition (PSR) set to 64 symbols length. Field 206 indicates Start of Frame Delimiter (SFD) number (e.g., 2) per table 15-7c of IEEE 802.15.4z that defines the configurations for the Physical Layer Header (PHR) data rate. Field 208 defines the SFD length (e.g., 8). Field 210 defines Scrambled Timestamp Sequence (STS), and number of segments (e.g., 1. Field 212 defines STS Segment Length (in units of 512 chips) (e.g., 64). Field 214 indicates the presence of Physical Layer Header (PLH) and data (e.g., Yes). Field 216 specifies data rate in Megabits per second (M b/s) (e.g., 6.8 Mb/s). Field 218 provides a description (e.g., SP1) that describes the intent of the set of configurations. The description appears in the specification document, but the description is not transmitted over the air. Additionally, the description refers to a frame format (also known as STS Packet Configuration (SP) and can be SP0, SP1, or SP3 based on FiRa.

In this context, aspects of the present disclosure consider a mono-static radar per anchor/AP that may rely on the same DTMs (e.g., structure 200a of FIG. 2A) for CIR extraction. In this case, a SYNC is 64 symbols length and BPRF set number is 3 as currently defined and indicated above.

FIG. 2B illustrates example modifications to DTM frames for enabling dual DL-TDoA and radar usage, according to some aspects of the present disclosure.

As shown in FIG. 2B, a number of parameters are defined within a DTM structure such as DTM 200b according to the standards. These parameters are labeled as parameters 250 and will not be described in detail for sake of brevity. Each of these have a corresponding indicator (Y es, No, or Yes/No) for one of several One Way Ranging (OWR) message types including an initial poll message 252 (poll DTM), a response message 254 (response DTM), and a final message 256 (Final DTM).

According to one aspect of the present disclosure, several new parameters may be introduced into DTM 200b including, but not limited to, radar usage 258 and radar allowed 260.

Radar usage 258 may be selected to indicate one of mono-static, bistatic, and multi-static deployments (reach representing a different mode of radar operation). Radar usage 258 parameter may help the DT initiator anchors such as anchor 102, anchor 104, and/or anchor 106, or phone (DT-Tag) such as tag 108 and/or tag 110 to identify any possible degradation in the performance of DL-TDoA operation due to RF front-end changes of radar usage of the same DTMs. Additionally, or alternatively, final DTM can include radar usage 258 parameter that provide feedback for the usage of radar to a corresponding responder anchor. If the performance of DL-TDoA, such as received signal strength indicator (RSSI) or range standard deviation, are degraded, then the degradation can be reported back to the responder anchor to stop radar usage if DL-TDOA has higher priority.

In instances of mono-static radar deployment, if the default PHY configuration of the DTM is not favorable for radar usage or when the performance of normal DL-TDOA operation is impacted by the dual usage of DTM for both DL-TDOA and Radar, an extra ranging round may be introduced for mono-static radar usages. This mode of operation may involve the persistence of clustering for radar usage. In this instance, the role of anchors may be TRX Radar Anchor.

In case of mono-static radar deployment, the ranging round structure of radar can be different than DL-TDOA with condition that all of the radar RRs are after DL-TDoA RRs. This may be due to the fact that the DT-Tag is not aware of the presence of Radar RRs and may not be able to align the timing if the length of radar RRs in between is different than DL-TDoA RR. If the same length is selected, there may be no limitation on the location of the Radar RR in one ranging interval.

Furthermore, in case of mono-static radar deployment, given the shorter length of radar frames, the slot duration for RR can be selected differently subject to a constraint that the number of slots per RR meets the conditions described above (e.g., all of the radar RRs are after DL-TDoA RRs unless the same length is selected, in which case there may be no limitation on the location of the Radar RR in one ranging interval).

Slot assignments may be static or dynamic. In some examples, in the static slot assignment scenario, the number and the order of slots that radar frames are sent in the corresponding RR may be determined by Real-Time Locating System (RTLS)/central configuration server (such as a server 112 or an application layer server 114 shown in FIG. 1).

In the dynamic slot assignment scenario, the initiator anchor may provide the number of slots in each RR based on the “Radar Priority” and “number of the responder anchors” in the corresponding DL-TDoA RR of the cluster. In some examples, if there is less activity (or less CIR differences) at the responder anchor, the responder anchor can send back the number of slots in the response DTM with lower priority and vice versa. In the next ranging interval, poll message may include and provide the “Radar Slot Assignment” parameter.

Furthermore, in case of mono-static radar deployment, the radar frame (per slot) can be SP3 with no payload. However, the radar message may also provide information of the anchor such as Round Index, Block Index, Timestamp, Carrier Frequency Offset (CFO), anchor location, antenna configuration, etc. This data may be used by stationary devices, client devices, or client stations, such as laptops, in the future to use these radar frames to provide environment awareness without transmitting (i.e., bistatic).

Furthermore, in case of mono-static radar deployment, it is also possible that either the DT Tags or Radar RR is skipped. By way of a non-limiting example, if fast radar updates are required but DT Tags are not moving very fast (according to a movement threshold that may be determined based on experiments and/or empirical studies), a ranging interval of, for example, 100 ms may be considered where radar RRs come in each interval, but DT Tags comes every other interval.

In case of multi-static radar deployment, a case may be considered in which all the TX Radar-Anchors are directional antenna capable and can switch to directional antennas during their respective TX Radar RRs. The fact that the antennas are directional may result in very low inter-anchor signal reception during radar RR, which addresses the problem of dynamic range limitation (or saturation) of receivers due to high-power direct signals. According to some aspects of the present disclosure, the TX Radar-Anchor may not be matched to any specific DT role. For example, the TX Radar-Anchor need not be an initiator DT-Anchor.

In some examples, after the time alignment of all the anchors (based on the previous DL-TDoA procedure), each anchor may be able to perform a corresponding radar role in the corresponding Round Index. However, in some cases, there may no longer be any inter-anchor data transmission in such radar rounds since the TX Radar-Anchor is using a directional antenna. Accordingly, in some examples, the ranging round duration of Radar transmissions may be the same as the DL-TDoA RRs, depending on slot duration and the number of slots per RR. To match this condition, it may be possible for the slot duration of each RR for radar to be different so long as the number of slots per RR matches the total RR duration. Further, because the radar frames do carry a payload in the multi-static mode, a shorter slot duration may be selected to accommodate more slots per RR.

In some examples, in order to have consistent and coherent CIR measurements in each interval, CFO in each radar RR may be fully compensated. Subsequently, the radar ranging rounds may follow the DT RR corresponding to that cluster in each ranging interval. The round index of radar per radar group (which may include one TX Radar-Anchor and its corresponding RX Radar-Anchors) may be one plus the max RR index of the DT in the radar group. For example, if one radar group has 5 anchors (1 TX and 4 RX) with three from DT RR index 0 and two from DT RR index 2, the radar RR index may be larger than 2 (e.g., not 1, in this case) to ensure the measured CFO for the radar RR is not from the previous interval/block.

In some examples, the TX Radar-Anchors may not be directional antenna capable. In this case, signal processing methods (such as successive interference cancellation (SIC)) may be performed at the radar receivers to remove the direct TX impulses from the received signal, and to avoid a large ambiguity around the CIR at the distance of the TX anchor to the corresponding RX anchor. The SIC receiver may regenerate the TX radar frame(s) and remove the TX radar frame(s) from the received signal. These regenerated frame(s) (to be removed from RX signal) can be generated based on either using the detected/decoded frame(s) in the corresponding radar ranging round and/or based on channel information extracted from the previous DL-TDoA RR. Subsequently, the channel may be applied in the generated baseband preamble of the radar frame(s) to provide the CIR.

In CIR collection from UWB chips, there may be a large volume of data transfer from the chip to a host (and optionally to the RTLS server). For instance, each CIR can be 1016 complex numbers with 16 bits I and 16 bits Q, which amounts to a total of 4K bytes per frame/slot. According to aspects of the present disclosure, depending on the length of the ranging intervals, there may be instances where the buffer of the UWB module is still not empty, such that the UWB module will not be able to capture a new CIR. In this case, it may be more optimal not to use the airtime for radar if the receiver(s) is/are not able to measure CIR in real-time. Therefore, for the message types 0x2 and 0x3, (e.g., Poll DTM and Response DTM), as shown in FIG. 2B, “Buffer Status Request” and “Buffer Status Report,” parameters, respectively, may be added.

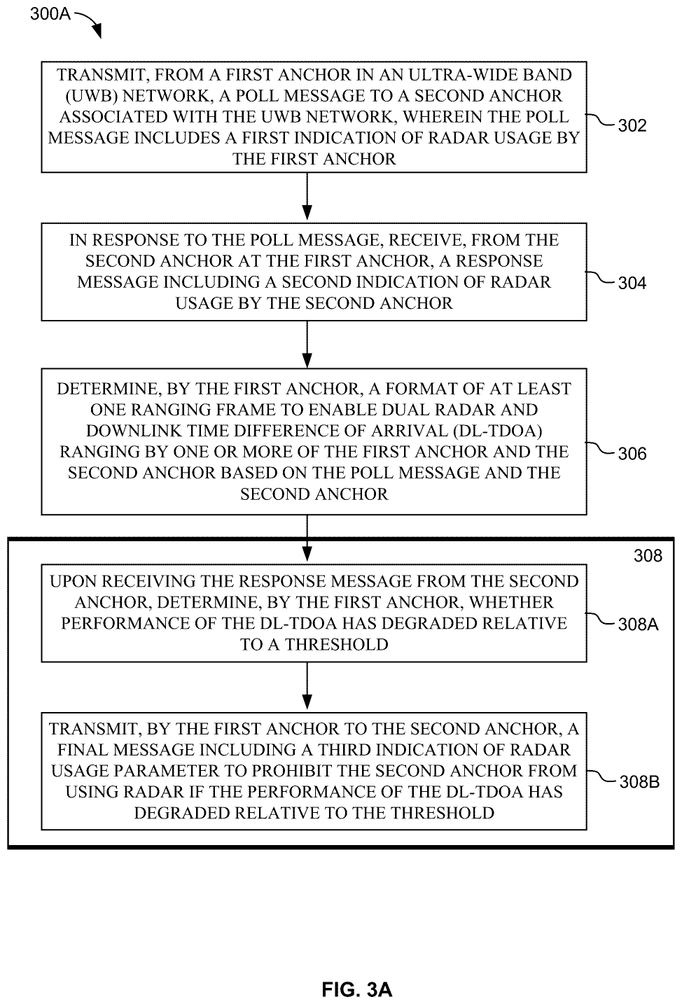

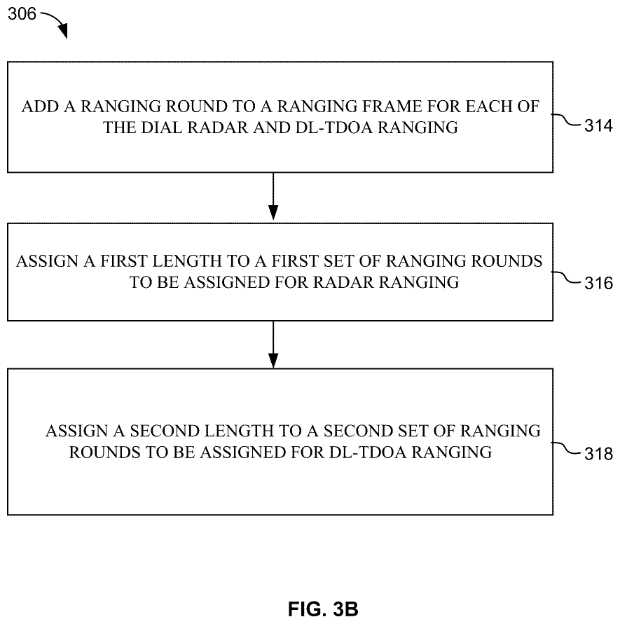

FIG. 3A and FIG. 3B each illustrates a flow-chart of an example method that enables dual radar detection and FiRa DL-TDoA operations, according to some aspects of the present disclosure.

FIG. 3A illustrates a flow-chart 300A of an example method for enabling UWB Radar detection on FiRa-enabled systems. Although the example routine 300A depicts a particular sequence of operations, the sequence may be altered without departing from the scope of the present disclosure. For example, some of the operations depicted may be performed in parallel or in a different sequence that does not materially affect the function of the routine 300A. In other examples, different components of an example device or system that implements the routine 300A may perform functions at substantially the same time or in a specific sequence. FIG. 3A and various steps thereof are described from the perspective of an anchor (e.g., an anchor 102 or 104 shown in FIG. 1). However, the present disclosure is not limited thereto.

The method includes, at step 302, transmitting a poll message from a first anchor in an UWB network (for example, shown in FIG. 1 as anchor 102) to a second anchor in the UWB network (for example, show in FIG. 1 as anchor 104). The poll message may be a 0x2 OWR message type (or a poll Device Test Mode (DTM) frame) shown in FIG. 2B. In one example, the poll message includes a first indication of radar usage by the first anchor. In one example the first indication identifies a mode of radar usage by the first anchor

The method includes, at step 304, receiving at the first anchor from the second anchor a response message. The response message is received at the first anchor in response to the poll message transmitted by the first anchor at step 302. The response message may be a 0x3 OWR message type (or a response DTM frame) shown in FIG. 2B. In one example, the response message includes a second indication of radar usage by the second anchor. The second indication identifies a mode of radar usage by the second anchor.

The mode of radar usage by the first anchor and/or the second anchor can include one or more of a mono-static radar mode, a bistatic radar mode, or a multi-static radar mode.

In one example, the poll message may include a buffer status request, and the response message may further include a buffer status report parameter. Airtime usage for radar by the second anchor may be prohibited based on information included in the buffer status report parameter, as described herein. For example, as described earlier, in CIR collection from UW B chips, there may be a large volume of data transfer from the chip to a host (and optionally to the RTLS server, which amounts to a total of 4K bytes per frame/slot. Further, depending on the length of the ranging intervals, there may be instances where the buffer of the UWB module may not be empty preventing the UWB module from capturing a new CIR. In such cases, it may be more optimal not to use the airtime for radar if the receiver(s) is/are not able to measure CIR in real-time. The buffer status request and accordingly the buffer status report parameter can convey the buffer information in order to probit airtime usage by the radar.

The method includes, at step 306, determining a format (e.g., number of ranging rounds for radar and/or DL-TDoA in each ranging frame, number of slots, duration of each slot, placement of ranging rounds in a ranging frame, etc.) of at least one ranging frame to enable dual radar and DL-TDoA ranging by the first anchor and/or the second anchor based upon the transmitted poll message and/or the received poll response message. As described herein, the format of the ranging frame may be dependent on the radar mode deployed at the first anchor or the second anchor, which can be determined based upon the transmitted poll message and the received response message.

For instance, the performance of the DL-TDoA includes RSSI and range standard deviation. Further, when the first anchor and/or the second anchor both operate in the mono-static radar mode, as shown in FIG. 3B, determining the format of the ranging frame, at step 306, further includes adding a ranging round to a ranging frame for each of the dual radar and DL-TDoA ranging as shown in FIG. 3B as step 314, and assigning a first length to a first set of ranging rounds to be assigned for radar ranging as shown in FIG. 3B as step 316, and assigning a second length to a second set of ranging rounds to be assigned for DL-TDoA ranging that is shown in FIG. 3B as step 318.

In some examples, the second length may be different from the first length, and the second set of ranging rounds may be before the first set of ranging rounds in the ranging frame such as, a ranging frame shown in FIG. 2A. The first length of each slot in the first set of ranging rounds may be shorter or longer than the second length of each slot in the second set of ranging rounds. Alternatively, the second length of each slot in the second set of ranging rounds may be same as the first length of each slot in the first set of ranging rounds. The first anchor and the second anchor each may be configured to operate as a transmitting and receiving radar anchor.

Further, determining the format of the ranging frame, at step 306, further includes either static or dynamic slot assignment. In the static slot assignment, a slot is assigned using or utilizing a number and an order for the first set of ranging rounds. The number and order of the slot for the first set of ranging rounds may be provided by a central configuration server (such as a server 112 or an application layer server 114 shown in FIG. 1).

In the dynamic slot assignment, the first anchor provides a number of slots in the first set of ranging rounds based on a radar priority number of the second anchor. By way of an example, the first and the second anchors may be in the same cluster of anchors. Further, the first anchor and/or the second anchor may have a multi-static mode of radar usage. The first anchor and/or the second anchor may have directional antennas. The duration of each radar ranging round in the ranging frame may be equal to a duration of each DL-TDoA ranging round in the ranging frame. Further, a number of slots and/or a corresponding duration for each slot of the number of slots in the radar ranging round may depend on, or subject to, the duration of each radar ranging round being equal to the duration of each DL-TDoA ranging round.

In another example, when the first anchor and/or the second anchor both operate in the multi-static radar mode, the format of the ranging frame may be determined as described above with reference to FIGS. 2A and 2B (e.g., for directional antenna capable transmitting radar-anchors, for non-directional antenna capable transmitting radar-anchors, etc.).

Alternatively, or additionally, in the multi-static mode of radar usage, the first anchor or the second anchor may not have antennas with directional antenna capabilities. Accordingly, the second anchor or the first anchor may perform successive interference cancellation. The successive interference cancellation, as described herein, may include regenerating radar frames that are included in a signal received from the first anchor based on frames detected during a radar ranging round, or based on channel information that is extracted from a previous DL-TDoA ranging round. The channel information is applied to a baseband preamble in the radar frames to determine a radar channel impulse response, and to remove the frames (or the radar frames) from the signal.

Returning back to FIG. 3A, the method further includes, at step 308A, determining whether performance of the DL-TDoA is degraded relative to a threshold. Determination of the degradation of performance of the DL-TDoA is made by the first anchor in response to receiving the response message such as, 0x3 OWR message type (or the response DTM frame) shown in FIG. 2B. Based upon the determined degradation of performance of the DL-TDoA, the method further includes, at step 308B, the first anchor transmitting a final message such as, 0x4 OWR message type (or a Final DTM frame) shown in FIG. 2B. The final message includes a third radar usage parameter that is used for prohibiting the second anchor from using the radar if DL-TDoA has a higher priority than the priority of radar operations. In one example, steps 308A and 308B, shown in FIG. 3A as a combined step 308, are optional steps.

The method may further include compensating for Carrier Frequency Offset (CFO) in one or more radar ranging rounds, or each radar ranging round. CFO can be performed in a number of different ways. For example, CFO is typically achieved based on the observed position in the spectrum and the time domain of the received pulse, and comparing the observed position with a theoretical position and then adjusting the receiver to compensate for the observed deviation between the theoretical position and the observed position. Further, the CFO is generally estimated from a preamble of the frame such as a frame shown in FIG. 2A.

In one example, the first anchor and the second anchor may be associated with a radar group including a plurality of radar-enabled anchors. A round index for radar ranging may be one plus a maximum round index for DL-TDoA ranging in the radar group. Further, the first anchor and/or the second anchor may have a bistatic model of radar usage.

Accordingly, various aspects described in the present disclosure provide a seamless combination of FiRa DL-TDoA and UWB radar functionalities within a single operational framework. This enables dual-use capabilities without requiring separate infrastructure, providing significant cost and complexity advantages. Further, TX Radar-Anchor and RX Radar-Anchor roles enable mono-static and multi-static radar operations that ensure flexibility and scalability for diverse enterprise use cases, such as precise mapping and presence detection. Adaptive slot allocation based on radar priority, as described herein, ensures resource optimization while dynamically adjusting to real-time demands, preventing resource conflicts, and maximizing system efficiency. Additionally, various aspects provide a unique solution to handle CIR data transfer bottlenecks and maintain real-time performance by ensuring uninterrupted operations by optimizing data handling between UWB chips and hosts. Feedback-driven adaptation, as described herein, prioritizes radar or positioning based on real-time metrics that allows seamless switching based on operational needs, ensuring consistent and reliable performance.

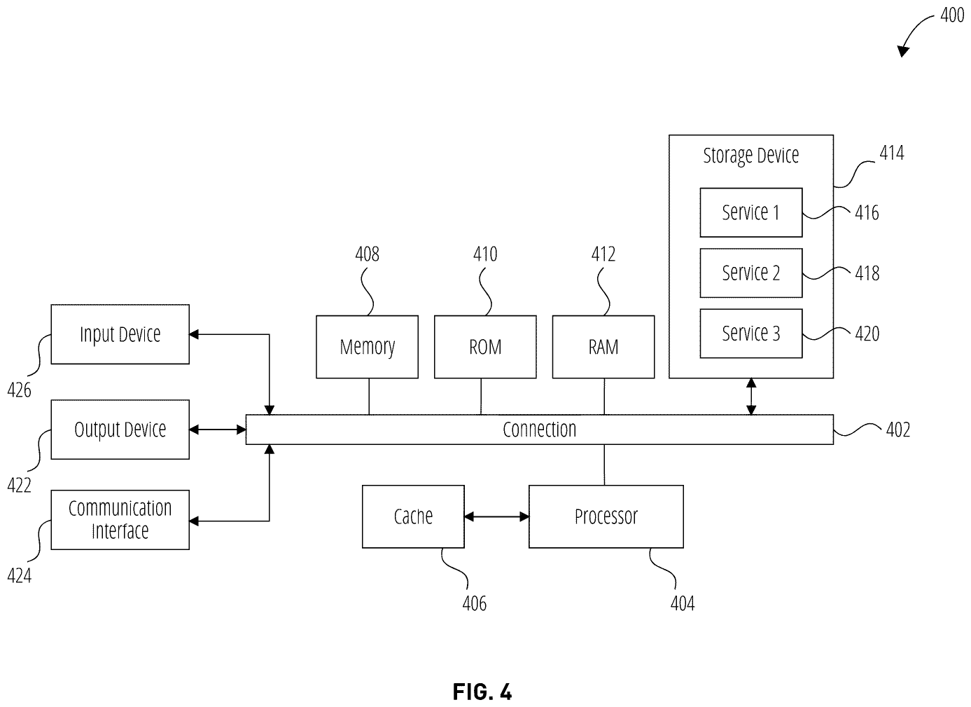

FIG. 4 shows an example of computing system 400, which can be for example any computing device making up the communication architecture described in FIG. 1, or any component thereof in which the components of the system are in communication with each other using connection 402. Connection 402 can be a physical connection via a bus, or a direct connection into processor 404, such as in a chipset architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represent many such components each performing some or all of the functions for which the component is described. In some embodiments, the components can be physical or virtual devices.

Example computing system 400 includes at least one processing unit (CPU or processor) such as processor 404 and connection 402 that couples various system components including system memory 408, such as read-only memory (ROM) such as ROM 410 and random-access memory (RAM) such as RAM 412 to processor 404. Computing system 400 can include a cache of high-speed memory 406 connected directly with, in close proximity to, or integrated as part of processor 404.

Processor 404 can include any general-purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
transmitting, from a first anchor in an Ultra-Wide Band (UWB) network, a poll message to a second anchor associated with the UWB network, wherein the poll message includes a first indication of radar usage by the first anchor;
in response to the poll message, receiving, from the second anchor at the first anchor, a response message including a second indication of radar usage by the second anchor; and
determining, by the first anchor, a format of at least one ranging frame to enable dual radar and downlink time difference of arrival (DL-TDoA) ranging by one or more of the first anchor and the second anchor based on the poll message and the response message.

2. The method of claim 1, wherein:
the first indication and the second indication identify a mode of radar for the radar usage by the first anchor and the second anchor, respectively, the mode of radar including one of a mono-static radar, a bistatic radar, or a multi-static radar.

3. The method of claim 1, further comprising:
upon receiving the response message from the second anchor, determining, by the first anchor, whether performance of the DL-TDoA has degraded relative to a threshold; and
transmitting, by the first anchor to the second anchor, a final message including a third indication of radar usage parameter to prohibit the second anchor from using radar if the performance of the DL-TDoA has degraded relative to the threshold,
wherein the performance of the DL-TDoA is determined based upon one or more of Received Signal Strength Indicator (RSSI) and range standard deviation.

4. The method of claim 1, wherein at least one of the first anchor and the second anchor operates in a mono-static radar mode, and determining the format of the at least one ranging frame comprises:
adding a ranging round to the at least one ranging frame;
assigning a first length to a first set of ranging rounds to be assigned for radar ranging; and
assigning a second length to a second set of ranging rounds to be assigned for DL-TDoA ranging,
wherein the second set of ranging rounds is before the first set of ranging rounds in the at least one ranging frame.

5. The method of claim 4, wherein the first length is different than the second length.

6. The method of claim 4, wherein at least one of the first anchor and the second anchor is configured to operate as a transmitting and receiving radar anchor, and wherein determining the format of the at least one ranging frame includes a static slot assignment or a dynamic slot assignment.

7. The method of claim 4, wherein a duration of each radar ranging round in the at least one ranging frame is equal to a duration of each DL-TDoA ranging round in the at least one ranging frame.

8. The method of claim 1, wherein at least one of the first anchor and the second anchor operates in a multi-static radar mode or a bistatic radar mode with directional antennas.

9. The method of claim 1, wherein the second anchor performs successive interference cancellation by regenerating radar frames included in a signal received from the first anchor based on frames detected during a radar ranging round or based on channel information extracted from a previous DL-TDoA ranging round, and removing the radar frames from the signal, wherein the channel information is applied to a baseband preamble in the radar frames to determine a radar channel impulse response.

10. The method of claim 1, wherein:
the first anchor or the second anchor is associated with a radar group including a plurality of radar-enabled anchors; and
a round index for radar ranging is one plus a maximum round index for DL-TDoA ranging in the radar group.

11. An apparatus in an Ultra-Wide Band (UWB) network, the apparatus comprising:
at least one memory configured to store computer-readable instructions; and
at least one processor communicatively coupled with the at least one memory, and configured to execute the computer-readable instructions to perform operations comprising:
transmitting, to an anchor associated with the UWB network, a poll message including a first indication of radar usage by the apparatus;
in response to the poll message, receiving, from the anchor, a response message including a second indication of radar usage by the anchor; and
determining a format of at least one ranging frame to enable dual radar and downlink time difference of arrival (DL-TDoA) ranging by one or more of the apparatus and the anchor based on the poll message and the response message.

12. The apparatus of claim 11, wherein:
the first indication and the second indication identify a mode of radar for the radar usage by the apparatus and the anchor, respectively, the mode of radar including one of a mono-static radar, a bistatic radar, or a multi-static radar.

13. The apparatus of claim 11, wherein the operations further comprising:
upon receiving the response message from the anchor, determining whether performance of the DL-TDoA has degraded relative to a threshold; and
transmitting, to the anchor, a final message including a third indication of radar usage parameter to prohibit the anchor from using radar if the performance of the DL-TDoA has degraded relative to the threshold,
wherein the performance of the DL-TDoA is determined based upon one or more of Received Signal Strength Indicator (RSSI) and range standard deviation.

14. The apparatus of claim 11, wherein at least one of the apparatus and the anchor operates in a mono-static radar mode, and determining the format of the at least one ranging frame comprises:
adding a ranging round to the at least one ranging frame;
assigning a first length to a first set of ranging rounds to be assigned for radar ranging; and
assigning a second length to a second set of ranging rounds to be assigned for DL-TDoA ranging,
wherein the second set of ranging rounds is before the first set of ranging rounds in the at least one ranging frame.

15. The apparatus of claim 14, wherein the first length is different than the second length.

16. The apparatus of claim 14, wherein at least one of the apparatus and the anchor is configured to operate as a transmitting and receiving radar anchor, and wherein determining the format of the at least one ranging frame includes a static slot assignment or a dynamic slot assignment.

17. The apparatus of claim 14, wherein a duration of each radar ranging round in the at least one ranging frame is equal to a duration of each DL-TDoA ranging round in the at least one ranging frame.

18. The apparatus of claim 11, wherein at least one of the apparatus and the anchor operates in a multi-static radar mode or a bistatic radar mode with directional antennas.

19. The apparatus of claim 11, wherein the anchor performs successive interference cancellation by regenerating radar frames included in a signal received from the apparatus based on frames detected during a radar ranging round or based on channel information extracted from a previous DL-TDoA ranging round, and removing the radar frames from the signal, wherein the channel information is applied to a baseband preamble in the radar frames to determine a radar channel impulse response.

20. The apparatus of claim 11, wherein:
the apparatus or the anchor is associated with a radar group including a plurality of radar-enabled anchors; and
a round index for radar ranging is one plus a maximum round index for DL-TDoA ranging in the radar group.
